(19) United States
(12) Patent Application Publication
(10) Pub. No.: US 2026/0110830 A1
(43) Pub. Date: Apr. 23, 2026

(54) MANUFACTURING OF AN OPTICAL FILTER ASSEMBLY

(71) Applicant: ADMESY B.V., Ittervoort (NL)

(72) Inventor: Wim WELTJENS, Ittervoort (NL)

(21) Appl. No.: 19/114,244

(22) PCT Filed: Sep. 28, 2023
(86) PCT No.: PCT/EP2023/076883

§ 371 Date: Mar. 21, 2025

(30) Foreign Application Priority Data
Sep. 29, 2022 (EP) 22198696.1

(51) Int. Cl. G02B 5/20; B29D 11/00; G01J 3/02; G01J 3/28; G02B 7/00

(52) U.S. Cl. CPC G02B 5/201; B29D 11/00634; G01J 3/0262; G01J 3/2803; G02B 7/006; G01J 2003/2806; G01J 2003/2813

(57) ABSTRACT

An optical filter assembly comprises a plurality of optical filters and a filter frame holding the plurality of optical filters in a predefined pattern. A method for manufacturing such an optical filter assembly comprises providing diced optical filters, each optical filter having a specific spectral sensitivity. A mold is provided having an open top mold cavity and one or more filling ports which are in fluid communication with the mold cavity. The optical filters are picked and placed in the predetermined pattern in the mold cavity with a gap having a predetermined gap width between the optical filters. A channel grid is formed by the gaps between the optical filters. The channel grid is filled by feeding a liquid resin having a light blocking property to the one or more filling ports, wherein said resin and said gap width are adapted to distribute the resin in the channel grid by a capillary effect. The resin is allowed to cure so as to form the filter frame.

### FIELD OF THE INVENTION

The invention relates to a method for manufacturing an optical filter assembly. The invention further relates to an optical filter assembly manufactured according to the method, and an optical measurement device comprising the optical filter assembly. The invention also relates to a mold used in the method.

### BACKGROUND OF THE INVENTION

To measure color, various optical color measuring devices are known in the art, such as spectrometers and colorimeters.

In a colorimeter, each of the sensors of the colorimeter has a sensor filter that allows passage of part of the light spectrum while blocking another part of the light spectrum. This allows each sensor to provide a signal representative of the respective range in the light spectrum. However, in addition to the sensor filters, the colorimeter has various optical components, some of which may filter part of the light propagating towards the sensors. To take into account the filtering by these optical components, the sensor filters are optimized to take this additional filtering into account. For example, a sensor filter is optimized to allow light with a certain wavelength to pass through with minimal reduction of the intensity of the light, in case the light with this wavelength is partly filtered by another optical component. For example, the sensor filter is optimized to reduce the intensity of light with another wavelength passing through, in case the light with this wavelength is not or not significantly filtered by another optical component. Because of this optimization of the sensor filters, such sensor filters are complex and expensive.

Spectrometers are typically designed to determine a spectrum of wavelengths that is irradiated, absorbed or reflected by an object. A spectrometer, also referred to as an optical spectrometer, is an instrument that is able to determine an intensity of light as a function of wavelength. Although a spectrometer is typically able to provide detailed information about wavelengths which are present in a ray of light, a spectrometer is typically expensive and large due to its complex optical design.

In the co-pending non-published application EP 22182476.6 a method for manufacturing an optical filter assembly is disclosed, wherein the optical filter assembly comprises a plurality of filters, each having a specific spectral sensitivity, and a filter frame holding the plurality of filters in a predefined pattern. The filters are made of a substrate on which filter coatings are applied wherein a specific stack of coatings on the substrate is designed for the specific spectral sensitivity of the respective filter. The coatings may be applied by sputter depositing multiple molecular or atomic layers, e.g. by ion beam sputtering. The coated substrate is diced into substrate portions, the good ones of the substrate portions are selected to be used as a filter. The filters are arranged in a pattern in the filter assembly by a pick and place process.

US 2018/0180782 A1 discloses a method in which an array of optical filters is made by arranging, using a pick and place machine, a plurality of optical filters on a reconstitution substrate spaced apart by gaps. A molding compound, which may be a suitable thermosetting polymer, such as an epoxy, is applied around the optical filters and possibly on the backs side of the optical filters. Portions of the molding compound and the optical filters are thinned from the back side and the reconstitution substrate is removed from the front side. A disadvantage of this method is that it requires a post-processing step wherein a layer of the filters and the molding compound has to be removed by grinding or chemical-mechanical thinning by polishing or lapping.

JP 2009-139545 discloses an integral microlens array having grooves at a bottom side. The walls of the grooves are coated with a black powder. A sealing layer of a transparent, UV-curable resin is then applied on the bottom side and in the grooves by spin coating.

It is an object of the invention to provide a more efficient method to manufacture a filter assembly in which the filters are arranged in a filter frame.

This object is achieved by a method according to the invention.

### SUMMARY OF THE INVENTION

A method for manufacturing an optical filter assembly, wherein the optical filter assembly comprises a plurality of optical filters, each filter having a specific spectral sensitivity, and a filter frame holding the plurality of optical filters in a predefined pattern. The method comprises the following steps:
providing diced optical filters, each having a specific spectral sensitivity;
providing a mold having an open top mold cavity and one or more filling ports which are in fluid communication with the mold cavity;
arrange the optical filters in the predetermined pattern, e.g. in an array, in the mold cavity with a gap having a predetermined gap width between adjacent optical filters, such that a channel grid is formed by the gaps between the optical filters;
filling the channel grid by feeding a liquid resin having a light blocking property to the one or more filling ports, wherein said resin and said gap width are adapted to distribute the resin in the channel grid by a capillary effect;
allowing the resin to cure so as to form the filter frame.

The method according to the invention provides a fixed pattern of optical filters with a light blocking frame holding the filters. There is thus provided a fixed mosaic of optical filters, which can be used in a multichannel optical sensor. When the optical filter assembly is removed from the mold it can be applied in an optical measurement device without the need to post-process the filter array.

In an embodiment the at least one multichannel optical sensor comprises an array of photodiodes and an array of filters matched with the array of photodiodes, wherein the array of filters comprises different bandpass filters. It is noted here that the term “array” in this context means a grouped set of photodiodes or filters. This can be one row or column, or multiple rows and columns. Although in practise the array is usually rectangular, it does not have to be rectangular. Every channel of the sensor corresponds to at least one photodiode.

According to the invention the frame is made of a light blocking material, such that light falling on one filter in the pattern and which may be deviated, for example by refraction, cannot enter the adjacent filters in the pattern and “contaminate” the measurement by the photodiodes associated with said adjacent filters. In this way is warranted that the photodiode associated with an individual filter only detects light that is passing through the coated plane surface of said individual filter. This allows to perform very accurate spectral analysis of light emitted by a light source by means of the multichannel optical sensor.

According to the invention the gaps are filled with the light blocking resin by means of the capillary effect. This has the advantage over other possible methods to fill the gaps, e.g. by an injection head moving along the grid and injecting resin from above, or by injection of resin under pressure, that staining or partially covering the coated filter surfaces by the light blocking resin during filling of the channel grid during production is entirely prevented or at least the risk of staining or covering is reduced considerably. Stains or overflow by light blocking material of the coated filter surface would negatively influence the quality of the filter assembly and thus of the multichannel optical sensor it is incorporated in.

In the method according to the invention the optical filters are placed in the mold cavity such that the gap between the optical filters has the same width throughout the channel grid. This advantageously facilitates the capillary distribution of the liquid resin throughout the entire channel grid. The filters may advantageously be arranged in the mold by a pick and place process.

In the method according to the invention, the mold cavity preferably comprises a peripheral contour, wherein outer optical filters are placed in the mold such that a gap is formed between the peripheral contour and the outer optical filters which preferably is of the same width as the gap in-between the optical filters. The provision that the spacing between the filters and between the outer filters in the pattern and peripheral contour of the mold is the same, further facilitates the capillary distribution of the liquid resin throughout the channel grid.

The mold is oriented such that the array of filters is arranged in a horizontal plane, whereby a pure capillary effect is achieved and gravity does not influence the distribution of the resin in the channel grid.

Preferably the mold is filled by dropwise discharging liquid resin from a resin dripping device to the one or more filling ports. By dropwise feeding the resin, the feeding process is well controllable. More preferably the mold is filled through a plurality of the filling ports, wherein the filling ports are fed alternately. Thereby the distribution of the liquid resin in the channel grid is coming from more sides and a more uniform distribution of the flow of resin can be achieved.

According to a further aspect of the invention the channel grid is filled with the light blocking resin to a level which is below the level of an upper surface of the optical filters. This aspect warrants that no light blocking material extends beyond the coated surface of the filters in the pattern, which could in itself negatively influence the light incidence on the coated filter surface, but also would increase the risk of resin flowing over the edge onto the coated filter surface and possibly reduce the accuracy of the multichannel sensor. Moreover the prevention of overflow advantageously provides that the optical performance of the filter assembly made by the production method is constant. In practice the channel grid may for example be filled to a level which is about 70% of the height of the channel. However, also other filling rates are possible.

Preferably, after the light blocking resin is cured, the mold cavity is filled via the open top with a liquid transparent filling resin which fills up the channels of the channel grid and covers the entire surface of channels and optical filters. In this way, a transparent finish layer with an even surface is provided which advantageously protects the filter coatings of the filters in the filter assembly and absorbs any unevenness between the coated surfaces of the filters in the filter assembly.

The mold used in the method according to the invention may comprise a window frame having a through opening defining a peripheral contour of the mold cavity, wherein the through opening of the window frame is covered on one side by the bottom arranged against one side of the window frame.

Preferably, a backing layer having an adhesive side is arranged on the window frame with the adhesive side facing up to form the bottom of the mold cavity. The optical filters, which according to the invention are arranged, preferably picked and placed, in a predetermined pattern, e.g. in an array, in the mold cavity, are adhered to the adhesive side of the backing layer and thereby temporary held in place by the backing layer. The backing layer is removed after the resin forming the filter frame is cured and the optical filter assembly is removed from the die.

The backing layer preferably is a piece of dicing tape, more preferably is a UV curable dicing tape. Dicing tape is known as such from the semiconductor industry and is readily available in the market. The optical filters are adhered to the dicing tape and thereby temporary held in place by the dicing tape. In case a UV curable dicing tape is used, UV irradiation is used to reduce the adhesion of the dicing tape to enhance peelability of the dicing tape from the filter assembly an thus allow removal of the dicing tape after the resin forming the filter frame is cured.

A black epoxy resin may advantageously be used as a light blocking resin in the method according the invention.

As a filling resin, used according to an above described aspect of the invention, a transparent epoxy resin can be used.

In the method according to the invention it is also conceivable that another mold may be used, wherein the mold has a peripheral contour and a bottom defining the mold cavity. In such a mold the bottom and the peripheral contour may be formed in one piece. An adhesive layer such as a dicing tape can for example be arranged as an inlay on the bottom in the mold cavity.

The invention also relates to a mold for forming a filter frame in a method as described in the above.

Preferably the mold has an open top mold cavity defined by an outer contour and a bottom, and one or more filling ports which are in fluid communication with the mold cavity, wherein the one or more filling ports each comprise a filling hole and a feeding channel which is in communication with the filling hole and the mold cavity.

In a preferred embodiment the feeding channel opens up in the mold cavity at a level which is below the level of the upper surface of the optical filters which in use are arranged in the mold cavity. By this configuration the light blocking resin thus enters the mold cavity below the level of the coated upper surface of the filters, whereby the resin will not flow over the upper surface.

As mentioned in the above, the channel grid is preferably filled by dropwise discharging liquid resin from a resin dripping device to a plurality of filling ports in fluid communication with the mold cavity, wherein the filling ports are fed alternately, such that the distribution of the liquid resin in the channel grid is coming from more sides and a more uniform distribution of the flow of resin can be achieved.

To provide for this an embodiment of the mold according to the invention has a plurality of filling ports evenly distributed around the outer contour of the mold cavity.

In a further embodiment the mold is adapted to contain a predetermined pattern of optical filters with gaps between the optical filters having a predetermined width, and the feeding channel has a width which corresponds to said predetermined width of the gaps. The feeding channel having the same width as the gaps between the filters and the gaps between the outer filters and the peripheral contour of the mold cavity further facilitates a good distribution of the flow of liquid resin.

In a possible embodiment the mold comprises a window frame having a through opening defining the outer contour of the mold cavity, wherein the through opening of the window frame is covered on one side by the bottom arranged against one side of the window frame. In a possible further embodiment the bottom is formed by a backing layer having an adhesive side with the adhesive side facing the open top, wherein, preferably, the backing layer is a dicing tape, more preferably a UV curable dicing tape.

After the filter frame is cured, the filter assembly can be removed from the window frame such that it can be assembled with an array of photodiodes. It is also possible to just peel the backing layer and leave the filter assembly in the window frame. In the latter case, the window frame may be utilized to mount the filter assembly in front of an array of photodiodes. The invention also relates to a multichannel optical sensor comprising an array of photodiodes and an optical filter assembly manufactured according to the method according to the invention, wherein the optical filter assembly is provided with an array of filters matching with the array of photodiodes.

Furthermore the invention relates to an optical measurement device comprising at least one multichannel optical sensor as mentioned in the preceding paragraph.

The invention will be further elucidated in the following description with reference to the drawings.

### BRIEF DESCRIPTION OF THE DRAWINGS

FIG. 1 shows a top elevational view of a filter assembly made according to the invention,

FIG. 2 shows schematically a cross section of a mold for making a filter according to the invention,

FIGS. 3A to 3D illustrate in a top elevational view how the mold of FIG. 2 if filled with a frame forming resin,

FIG. 4 shows a detail of FIG. 3B,

FIG. 5 illustrates schematically an unevenness between adjacent filters placed in the mold of FIG. 2,

FIG. 6 illustrates schematically the filters of FIG. 5 wherein the gaps are fully filled with a resin,

FIG. 7 illustrates schematically the filters of FIG. 5 wherein the frame is filled according to a further aspect of the invention, and

FIG. 8 shows schematically an optical measurement device including a multichannel optical sensor according to the invention.

### DETAILED DESCRIPTION

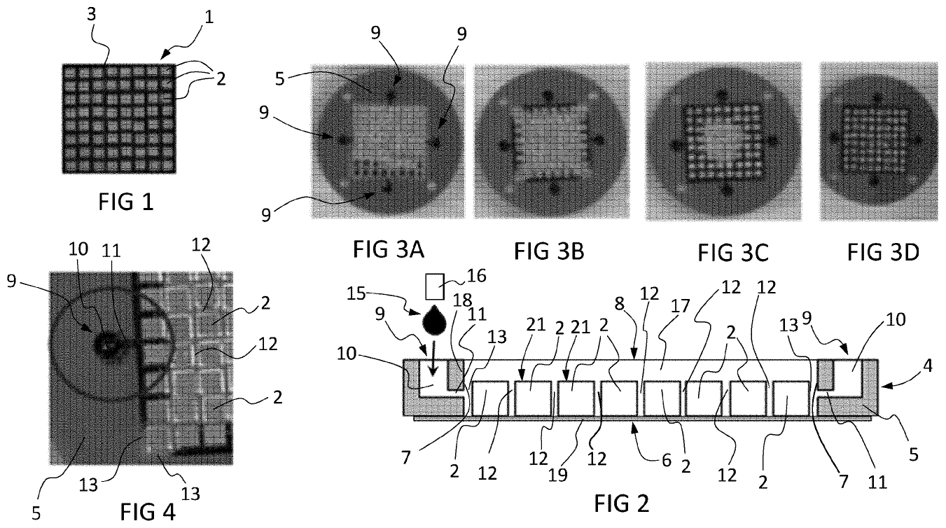

The invention relates to a method for manufacturing an optical filter assembly, and a filter assembly made by the method. FIG. 1 illustrates an optical filter assembly 1 according to the invention which comprises a plurality of optical filters 2. The filters 2 are arranged in a predetermined pattern in this example in an array of 64 filters 2 in a square 8 ×8 configuration. Each filter 2 has a specific spectral sensitivity. In the array all filters may have a different spectral sensitivity, but it is also possible that multiple filters 2 have the same spectral sensitivity. For the present invention the choice of the specific spectral sensitivity of the respective filters in the assembly 1 is not essential.

The filter assembly 1 furthermore comprises a filter frame 3 which holds the optical filters 2 in the predefined pattern, in this case thus in the square 8 ×8 configuration.

Filters 2 having a specific spectral sensitivity may be made of a substrate on which filter coatings are applied. A specific stack of filter coatings on the substrate is designed for the specific spectral sensitivity of the filters. The coatings on the substrate may be applied by sputter depositing multiple molecular or atomic layers, e.g. by ion beam sputtering. The coated substrate is diced into individual filters 2 to be used in the filter assembly 1. The dices all have the same dimensions.

The filters 2 are thus provided as dices, all having the same dimensions. The dices may for example be square having for example a dimension 1 mm×1 mm or 0,8 mm×0,8 mm, or even 0,4 mm×0,4 mm. The dices have to be placed in a certain pattern, in the example in an array of 8×8 filters 2. This is done by using a pick and place device, which picks the desired filter from a batch of filters and places it in the pattern, in this case the array at a predetermined position.

FIG. 2 illustrates a mold 4 used to make the assembly 1. The mold 4 comprises a window frame 5 having a through opening defined by a peripheral contour our outer contour 7 is formed by side walls 18. The through opening of the window frame 5 is covered on one side by a bottom 6 arranged against one side of the window frame 5. The bottom 6 is in use held horizontal. The side walls 18 and the bottom 6 define a mold cavity 17 with an open top side 8. The mold in the example shown has filling ports 9 at a distance from the side walls 18. The filling ports 9 each comprise a filling hole 10 and a feeding channel 11 which establishes a fluid communication between the filling hole 9 and the mold cavity 17.

The bottom 6 is formed by a backing layer 19 having an adhesive side facing upwardly towards the open top 8. The backing layer 19 may be a piece of dicing tape, preferably a UV curable dicing tape, which as such is a known product.

The filters 2 are placed in the mold cavity 17 on the adhesive side of the bottom 6/backing layer 19 with a gap 12 between them. A pick and place device, e.g. a robot, which is automatically controlled, may do this based on coordinates. In a possible method a position where a first filter 2 in the array is positioned, e.g. in a corner of the mold, may be used as a reference position in the mold for placement of the other filters in the mold. However, it is also possible to place filters 2 purely based on a coordinate system. The gaps 12 have a predetermined width such that a channel grid is formed by the gaps 12 between the optical filters 2. The channel grid is best visible in FIG. 3A. The gap 12 between the optical filters 12 has the same width throughout the channel grid. The outer optical filters 2 in the array are placed in the mold cavity 17 such that a gap 13 is formed between the peripheral contour 7 (the inner surface of the respective side walls 18) and the outer optical filters 2 which is the same as the gap 12 in-between the optical filters 2. The feeding channel 11 of the filling ports 9 has a width which corresponds to the predetermined width of the gaps 12 and 13.

The width of the gaps 12, 13 and the feeding channel 11 is designed such that when an amount of a curable liquid resin is added to the filling hole 10 of the filling port 9, the resin will distribute itself due to a capillary effect through the channel 11 and the gaps 12 and 13, which form the channel grid.

The liquid resin may be a black epoxy resin. The array of filters is arranged in a horizontal plane when the resin is fed to the mold. In FIGS. 3B to 3D is shown that the black epoxy resin is added alternately via the four filling ports 9 on the respective sides of the square array and illustrates how the black epoxy resin distributes itself from the ports 9 through the gaps 12 and 13 towards the center of the array. The horizontal arrangement of the array makes that a the distribution of resin is purely based on the capillary effect and not influenced by gravity, which result in a desired uniform distribution of resin. The liquid epoxy resin is discharged as a drop 15 of resin from a resin dripping device 16 to the filling ports 9, which is indicated in FIG. 2 at the left port 9 in the figure. When the epoxy resin is cured it is adhered to the filters.

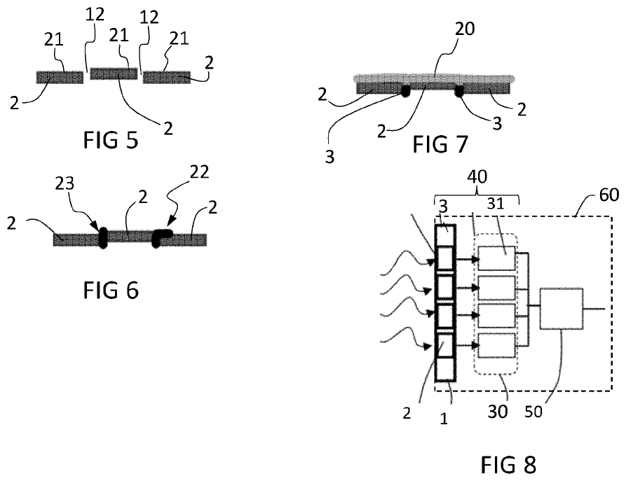

Although in FIG. 2 the upwardly facing sides 21 of the filters 2 appear to be on the same level, it is in practice often not possible to place the upwardly facing sides 21 exactly in the same plane. This is illustrated in FIG. 5, in which three filters 2 in height direction have slightly offset upper surfaces 21. The upwardly facing surface 21 is in general the surface where the filter coatings are applied. A problem that might occur when the channel grid is filled up to the upper edge of the filters 2 with a black resin is that an overflow of resin occurs and covers a part of the upper surface 21 of the filter 2. This is illustrated in FIG. 6 at the point indicated by reference numeral 22. Moreover, upwardly protruding edges 23 may be formed by the black resin, which can hamper light incidence on the upper surface 21 of the filter 2.

According to a preferred aspect of the invention the channel grid is filled with the black resin to a level which is below the level of an upper surface of the optical filters. In a practice the channel grid may be filled to a level which is about 70% of the height of the channel. This is shown in FIG. 7. To make this possible the feeding channel 11 of the filling ports 9 opens up in the mold cavity 17 below the upper surface 21 of the filters as can be seen in FIG. 2.

Also illustrated in FIG. 7 is that, after the light blocking resin is cured, the mold cavity is filled from the open top with a liquid transparent filling resin, such as a transparent epoxy resin, which fills up the channels and covers the entire surface of channels and optical filters 2. Thus, a transparent finish layer 20 is formed which provides an even top surface. The finish layer 20 made of the cured transparent (epoxy) resin advantageously protects the filter coatings of the filters 2 in the filter assembly 1 and absorbs any unevenness between the coated surfaces 21 of the filters 2 in the filter assembly 1. Moreover, since the epoxy adheres to the filters 2, the filter assembly 1 obtains increased stability and strength.

After the frame 3, and in some embodiments the finish layer 20, is cured and rigid enough, the filter assembly 1 can be removed from the mold. At this stage the backing layer 6 can be removed from the back of the filter assembly 1. In case the backing layer 19 is formed by a UV curable dicing tape, UV irradiation of the tape can be used to facilitate peeling of the backing layer 19 from the filter assembly 1. The filter assembly 1 can be removed from the window frame 5. It is also possible to just peel the backing layer 6 and leave the filter assembly 1 in the window frame 5. The window frame 5 may in such an embodiment be used to mount the filter assembly 1 in front of an array of photodiodes.

The filter assembly 1 may be used in a multichannel optical sensor 40. The multichannel optical sensor 40 comprises an array 30 of photodiodes 31 and an array of filters 1 matched with the array of photodiodes (cf. FIG. 8), i.e. the array of filters and the array of photodiodes are aligned such that each filter 2 is in line with a photodiode 31. The photodiodes 31 can be incorporated in a photo-sensitive layer. The array of filters 1 comprises different narrow bandpass filters. Such a sensor, if having sufficient filters/channels, can accurately indicate the spectral “fingerprint” of the light it detects. In FIG. 1 is shown the example of an array of filters 2, in this example a square array of 8×8=64 filters. Each of the 64 filters 2 may be a different narrow bandpass filter that allows light with a certain narrow wavelength range to pass. The filter assembly 1 comprising an array of filters 2 is associated with an array of optical sensors in this case photodiodes. In FIG. 8 is illustrated how a filter array 1 is positioned in front of a light sensitive sensor array 30, such that each individual filter 2 of the filter assembly 1 is aligned with a sensor 31 of the sensor array 30. As mentioned, the sensors 31 may be photodiodes made into a photosensitive layer. The multichannel optical sensor 40 may in essence be configured like this. Thus the multichannel optical sensors 40 can detect the luminance of the light at different selected wavelengths. The multichannel optical sensor 40 can be connected to a signal processing unit 50 shown in FIG. 8 and be incorporated in a optical measurement device 60, which may be a colorimeter.

1. A method for manufacturing an optical filter assembly, wherein the optical filter assembly comprises:
a plurality of optical filters each filter having a specific spectral sensitivity, and
a filter frame holding the plurality of optical filters in a predefined pattern; the method comprising the following steps:
providing diced optical filters each having a specific spectral sensitivity;
providing a mold having an open top mold cavity and one or more filling ports which are in fluid communication with the mold cavity;
arrange the optical filters in the predetermined pattern, in the mold cavity with a gap having a predetermined gap width between adjacent optical filters, such that a channel grid is formed by the gaps between the optical filters;
filling the channel grid by feeding a liquid resin having a light blocking property to the one or more filling ports, wherein said resin and said gap width are adapted to distribute the resin in the channel grid by a capillary effect;
allowing the resin to cure so as to form the filter frame.

2. The method according to claim 1, wherein the optical filters are placed the mold cavity such that the gap between the optical filters has the same width throughout the channel grid.

3. The method according to claim 1, wherein the mold cavity comprises a peripheral contour, wherein outer optical filters are placed in the mold such that a gap is formed between the peripheral contour and the outer optical filters.

4. The method according to claim 1, wherein the mold is filled by dropwise discharging liquid resin from a resin dripping device to the one or more filling ports.

5. The method according to claim 4, wherein the mold is filled through a plurality of the filling ports, wherein the filling ports are fed alternately.

6. The method according to claim 1, wherein the resin is a black epoxy.

7. The method according to claim 1, wherein the channel grid is filled with the light blocking resin to a level which is below the level of an upper surface of the optical filters.

8. The method according to claim 7, wherein, after the light blocking resin is cured, the mold cavity is filled via the open top with a liquid transparent filling resin which fills up the channels of the channel grid and covers the entire surface of channels and optical filters.

9. The method according to claim 1, wherein the mold comprises a window frame having a through opening defining a peripheral contour of the mold cavity, wherein the through opening of the window frame is covered on one side by the bottom (6) arranged against one side of the window frame.

10. The method according to claim 9, wherein, before the optical filters are placed, a backing layer having an adhesive side is arranged on the window frame with the adhesive side facing up to form the bottom of the mold cavity.

11. The method according to claim 10, wherein the backing layer is removed after the resin is cured, and wherein, the backing layer is a piece of UV curable dicing tape, and UV irradiation is used to reduce the adhesion of the dicing tape to allow removal of the dicing tape from the filter assembly.

12. The method according to claim 1, wherein the mold has a peripheral contour and a bottom defining the mold cavity.

13. (canceled)

14. A mold for forming a filter frame (3) in a method according to claim 1 wherein the mold has an open top mold cavity defined by a peripheral contour and a bottom and one or more filling ports which are in fluid communication with the mold cavity wherein the one or more filling ports each comprise a filling hole and a feeding channel which is in communication with the filling hole and the mold cavity.

15. The mold according to claim 14, wherein the feeding channel opens up in the mold cavity at a level which is below the level of the upper surface of the optical filters which in use are arranged in the mold cavity.

16. The mold according to claim 14, wherein the mold is provided with a plurality of filling ports evenly distributed around the peripheral contour of the mold cavity.

17. The mold according to 14, wherein the mold is adapted to contain a predetermined pattern of optical filters with gaps between the optical filters having a predetermined width, and wherein the feeding channel has a width which corresponds to said predetermined width of the gaps.

18. The mold according to claim 14, wherein the mold comprises a window frame having a through opening defining the peripheral contour of the mold cavity, wherein the through opening of the window frame is covered on one side by the bottom arranged against one side of the window frame.

19. The mold according to claim 18, wherein the bottom is formed by a backing layer having an adhesive side with the adhesive side facing the open top.

20. A multichannel optical sensor comprising an array of photodiodes and an optical filter assembly manufactured according to the method according to claim 1, wherein the optical filter assembly is provided with an array of filters matching with the array of photodiodes.

21. An optical measurement device comprising at least one multichannel optical sensor according to claim 20.
